(19) United States
(12) Patent Application Publication
(10) Pub. No.: US 2017/0068986 A1
(43) Pub. Date: Mar. 9, 2017

(54) INTERACTIVE SPONSORED EXERCISES

(71) Applicant: Duolingo, Inc., Pittsburgh, PA (US)

(72) Inventors: Brooke Elizabeth Chan, Pittsburgh, PA (US); Regina Gotthilf, Pittsburgh, PA (US); Gregory David Hartman, Pittsburgh, PA (US); Tyler Murphy, Pittsburgh, PA (US); Awaneesh Verma, Pittsburgh, PA (US); Luis Alfonso von Ahn Arellano, Pittsburgh, PA (US); Rogelio Alvarez Mury, Pittsburgh, PA (US)

(21) Appl. No.: 14/844,352

(22) Filed: Sep. 3, 2015

(51) Int. Cl. G06Q 30/02; H04L 29/08; H04L 29/06

(52) U.S. Cl. CPC G06Q 30/0245; H04L 67/42; H04L 67/16

(57) ABSTRACT

System and methods for generating and presenting interactive user activities that include sponsored content in accordance with some example embodiments are disclosed. The server system receives a request for additional interactive user exercises. In response to receiving a request from a client system, the server system selects one or more sponsored content items for a user associated with the client system, wherein the sponsored content items were created by one or more sponsors of an interactive user application. The server system transmits the sponsored content to the client system for display as part of an interactive user exercise, wherein the user is prompted to provide a response to the sponsored content. The server system receives from the client system a user response to the interactive user activity. The server system evaluates user engagement with the sponsored content items based on the received user response.

### TECHNICAL FIELD

Embodiments of the present disclosure relate generally to interactive applications and, more particularly, but not by way of limitation, to content selection for interactive applications.

### BACKGROUND

The rise in electronic and digital device technology has rapidly changed the way society interacts with media and consumes goods and services. Digital technology enables a variety of consumer devices to be available that are very flexible and relatively cheap. Specifically, modern electronic devices, such as smartphones and tablets, allow a user to have access to a variety of useful applications even when away from a traditional computer.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram further illustrating the client system of FIG. 1, in accordance with some example embodiments.

FIG. 3 is a block diagram further illustrating the server system of FIG. 1, in accordance with some example embodiments.

FIGS. 4A-4D illustrate an exemplary user interface for an interactive language learning application associated with a server system.

FIG. 5 is a block diagram demonstrating a module configuration, in accordance with some example embodiments, for generating a sponsored interactive user exercise and evaluating user responses.

FIGS. 6A-6C is a flow diagram illustrating a method, in accordance with some example embodiments, for generating and presenting interactive user activities that include sponsored content.

FIG. 7 is a block diagram illustrating an example of a software architecture that may be installed on a machine, according to some example embodiments.

FIG. 8 illustrates a diagrammatic representation of a machine in the form of a computer system within which a set of instructions may be executed for causing the machine to perform any one or more of the methodologies discussed herein, according to an example embodiment.

FIG. 9A illustrates an exemplary user interface for a sponsored exercise creation platform associated with a server system (e.g., the server system 120 in FIG. 1).

FIG. 9B illustrates an exemplary user interface for an interactive language learning application associated with a server system (e.g., the server system 120 in FIG. 1).

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments. It will be evident, however, to those skilled in the art, that embodiments of the inventive subject matter may be practiced without these specific details. In general, well-known instruction instances, protocols, structures, and techniques are not necessarily shown in detail.

Interactive, web-based applications are an increasingly important way of interacting with users. Such applications include games (e.g., trivia games, math-based games, learning applications (e.g., language learning applications, applications tailored to younger children such as shape or color learning applications, and so on), authentication applications (e.g., CAPTCHA applications, password applications, and so on), and so on. These applications transmit content for one or more exercises or activities from a server system to a user at a client system for presentation.

In some example embodiments, when a user wishes to use the web-based interactive application, the user instructs their client system to send a content request to the server system associated with the web-based interactive application. In some example embodiments, the client system uses a dedicated application to send the request. In other example embodiments, the request is sent using a web browser application. For example, if the interactive application is a language learning application, a user would request additional language learning exercises.

In response, the server system selects an exercise or activity to send to the client system for presentation. Continuing the example above, the server system selects a word or sentence for the user to translate. In some example embodiments, selection of the exercise or activity is based on stored information about the user's demographic information, history, demonstrated proficiency with past exercises, skills, and so on. In a learning application, the server system may select an exercise intended to teach the user the next skill appropriate to the user's current level.

The server system may select sponsored content for the user. This can be done based on the demographic information of the user, the needs of the sponsor (e.g., if a new product is being introduced to a particular geographic market, a sponsor may request that users who live in that geographic region would be more likely to be selected for a specific sponsored content item), or the analysis done by the server system.

Sponsored content includes content items associated with a sponsor, even if the content item is created by an ad agency rather than the actual sponsor. Sponsor content items include text, images, videos, animations, audio, objects, multi-media object, mascot, or any other media type. In some example embodiments, the content items include names or images of products or services.

A sponsor can include any person, organization, government, non-governmental organization, corporation, and any vendor of a product or service.

A user may be more likely to actively engage with sponsored content when it is delivered as part of an interactive activity the user already enjoys. For example, a sponsor could submit a question for a trivia game, such as “What new color of M&M was introduced in 1995 in response to the Color Campaign” with options of “Yellow”, “Green”, “Pink,’ and “Blue.” Thus, the actual content item itself is directly related to the sponsor, instead of just having branded content displayed near or on the content items.

Once a sponsored message is selected, the server system uses it to generate an appropriate interactive exercise which is transmitted to the client system for presentation to a user. An interactive exercise includes any content presented to a user through an electronic device to which the user responds. Exercises can include questions, quizzes, games, media to which a response is possible, lectures, examples, and so on. For example, a trivia question can be an exercise. Another example, includes an audio file that, when played, gives a user a prompt to provide a translation to the content included in the audio file. In another example, a sentence is provided in a first language and the exercise prompts the user to response with the correct translation in a second language.

The server system also determines which responses by a user will constitute a satisfactory response to the activity. For example, if a trivia question is generated, the server system will also determine what answers are acceptable for the generated questions. In the example of a language learning application, the server system will determine one or more acceptable translations of the sponsored sentence. In some example embodiments, the sponsor will provide the acceptable responses.

The user then creates a response (selects an option, types in an answer, speaks in response, and so on) to the exercise or activity. The response is recorded at the client system and transmitted to the server system.

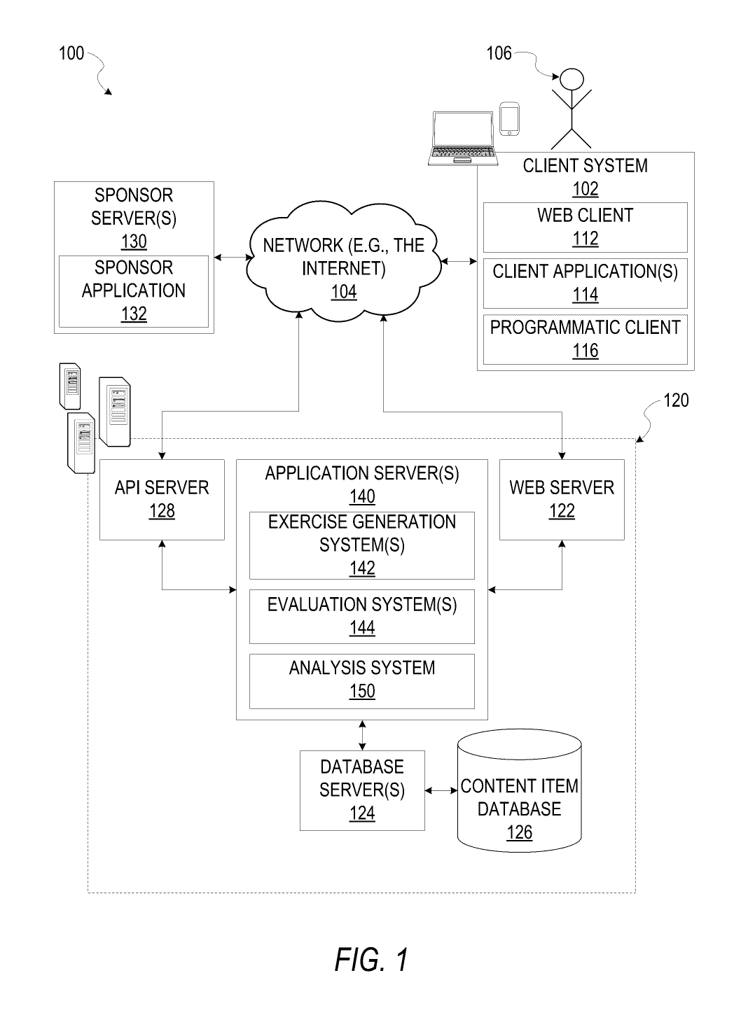

The server system (e.g., server system 120 in FIG. 1) receives the response and compares it against the predetermined list of one or more acceptable answers (quiz, math question, learning games). In some example embodiments, the user response is text typed by the user. In other example embodiments, the responses include a text response, an audio response, a gesture response, a visual response, an option selection response (e.g., selecting one or more of a plurality of presented options) and any other response possible.)

In some example embodiments, based on the response, the server system then determines a degree to which the user has engaged with the sponsored content.

With reference to FIG. 1, an example embodiment of a high-level client-server-based network architecture 100 is shown. A server system 120, in the example forms of a network-based application server system, provides server-side functionality via a network 104 (e.g., the Internet or wide area network (WAN)) to one or more client 102. FIG. 1 illustrates, for example, a web client 112 (e.g., a browser, such as the Internet Explorer® browser developed by Microsoft® Corporation of Redmond, Wash. State), client application(s) 114, and a programmatic client 116 executing on the client system 102.

The client system 102 may comprise, but is not limited to, a mobile phone, laptop, portable digital assistant (PDA), smartphone, tablet, ultra book, netbook, laptop, multi-processor system, microprocessor-based or programmable consumer electronics system, game console, set-top box, or any other communication device that a user, such as a user 106, may utilize to access the server system 120. In some embodiments, the client system 102 may comprise a display module (not shown) to display information (e.g., in the form of user interfaces). In further embodiments, the client system 102 may comprise one or more of a touch screen, accelerometer, gyroscope, camera, microphone, global positioning system (GPS) device, and so forth.

The client system 102 may be a device of the user 106 that is used to perform a transaction involving digital items within the server system 120. In one embodiment, the server system 120 is a network-based application server that responds to requests for interactive exercises, questions, game content, and so on. One or more users 106 may be a person, a machine, or other means of interacting with the client system 102. In embodiments, the user 106 is not part of the network architecture 100, but may interact with the network architecture 100 via the client system 102 or another means. For example, one or more portions of the network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client system 102 may include one or more applications (also referred to as “apps”) such as, but not limited to, a web browser, messaging application, electronic mail (email) application, one or more applications dedicated to particular services (e.g., a game application, learning application, and so on), and the like. In some embodiments, if an application dedicated to a web-based interactive service is included in a given client system 102, then this application is configured to locally provide the user interface and at least some of the functionalities of the interactive service, with the application configured to communicate with the server system 120, on an as needed basis, for data and/or processing capabilities not locally available (e.g., new content, to access a database of items available for sale, to authenticate a user, to verify a method of payment, etc.). Conversely, if the e web-based interactive service application is not included in the client system 102, the client system 102 may use its web browser to access the web-based interactive service hosted on the server system 120.

The one or more users 106 may be a person, a machine, or other means of interacting with the client system 102. For instance, the user 106 provides input (e.g., touch screen input or alphanumeric input) to the client system 102 and the input is communicated to the server system 120 via the network 104. In this instance, the server system 120, in response to receiving the input from the user 106, communicates information to the client system 102 via the network 104 to be presented to the user 106. In this way, the user 106 can interact with the server system 120 using the client system 102.

An application program interface (API) server 128 and a web server 122 are coupled to, and provide programmatic and web interfaces respectively to, one or more application servers 140. The application server(s) 140 may host one or more exercise generation system(s) 142, evaluation system(s) 144, and analysis system(s) 150, each of which may comprise one or more modules or applications and each of which may be embodied as hardware, software, firmware, or any combination thereof. The application server(s) 140 are, in turn, shown to be coupled to one or more database servers 124 that facilitate access to one or more content item storage repositories or database(s) 126. In an example embodiment, the content item database(s) 126 are storage devices that store information to be used by the exercise generation system(s) 142, the evaluation system(s) 144, and the analysis system(s) 150. The content item database(s) 126 may also store digital item information in accordance with example embodiments.

Additionally, a sponsor application 132, executing on sponsor server(s) 130, is shown as having access to the server system 120 via the interface provided by the API server 128 and the web server 122. For example, the sponsor application 132 is able to connect to the server system 120 to upload or alter sponsored content items stored in the content item database(s) 126.

The exercise generation system(s) 142 responds to requests from one or more client system 102 for further interactive exercises (e.g., additional trivia questions, translation prompts, new game levels, and so on). In response to receiving a content or exercise request from a client system 102, the exercise generation system(s) 142 selects one or more content items from the content item database 126. In some example embodiments, content items are selected based on the demonstrated skill of the user (e.g., user 106), the user's history with the web-based interactive service (e.g., what game levels have already been completed, what skills has the user already learned, and so on), a user's demographic information, and, if the content item is a sponsored exercise, the specific guidelines set by the sponsor (e.g., an organization that is advertising to users through the sponsored exercise).

In some example embodiments, the exercise generation system(s) 142 also creates or accesses a list of acceptable user responses to the generated or selected exercise. For example, if the exercise is a translation exercise for a learning application, the list of acceptable user responses includes all valid translations of the word or phrase that is part of the exercise. In some example embodiments, the exercise generation system(s) 142 also generates or accesses hints to be conditionally displayed to a user (e.g., the user can select to receive one or more hints for a given exercise). In some example embodiments, the hints are provided by the sponsor and help engage the user and deliver the sponsored message effectively.

The evaluation system(s) 144 receives users' responses to the interactive exercises sent from the server system 120. The evaluation system(s) 144 then compares the received response to the one or more acceptable solutions to the exercise. The evaluation system(s) 144 then determines whether the user has correctly solved the exercise. In some example embodiments, the user response is in text. In other example embodiments, the user response is recorded in an audio file that is analyzed to determine what words were spoken by the user before the correctness of the response can be evaluated.

In some example embodiments, the evaluation system(s) 144 determines that the user response contains one or more informal or typographical errors such that it is clear that the user answered correctly but made one or more spelling, punctuation, or small grammatical error. In this case, the evaluation system(s) 144 may give partial or total credit to the user for a correct response.

The analysis system(s) 150 uses the information about sponsored content (e.g., what the sponsored content was, what goal was intended to be achieved by sharing the sponsored content with the user, and so on) and information about the user's response (e.g., the evaluation system(s) 144 can reveal whether the user properly responded to the sponsored activity) to analyze whether the user had effectively engaged with the sponsored content. For example, if the user is given three sponsored messages over a two-day period, and the user gradually increases in proficiency (e.g., originally misuses a branded term but then uses it correctly in the last exercise), the analysis system(s) 150 determines that the user has increased their engagement with and awareness of the sponsor (or the sponsor's product).

In some example embodiments, the analysis system(s) 150 can use additional means to determine the effectiveness of branded content, including, but not limited to, user surveys.

Further, while the client-server-based network architecture 100 shown in FIG. 1 employs client-server architecture, embodiments are not limited to such an architecture, and could equally well find application in a distributed, or peer-to-peer, architecture system, for example. The various exercise generation system(s) 142, evaluation system(s) 144, and analysis system(s) 150 could also be implemented as standalone software programs, which do not necessarily have networking capabilities.

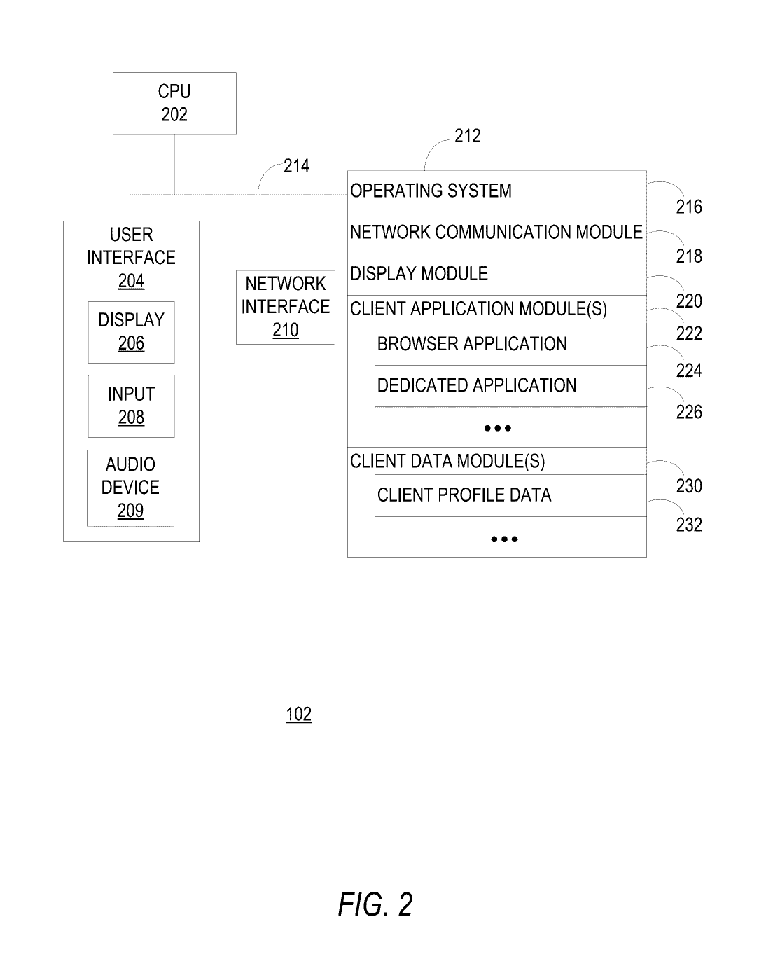

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input device 208 such as a keyboard, mouse, touch sensitive display, or other input means. Furthermore, some client systems 102 use a microphone and voice recognition, such as an audio device 209, to supplement or replace other input devices.

The memory 212 includes high-speed random access memory, such as dynamic random-access memory (DRAM), static random access memory (SRAM), double data rate random access memory (DDR RAM) or other random access solid state memory devices, and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more network interfaces 210 (wired or wireless) and one or more communication networks 104, such as the Internet, other WANs, LANs, MANs, etc.;
a display module 220 for enabling the information generated by the operating system 216 and the client application(s) 114 to be presented visually on the display device 206;
one or more client application modules 222 for handling various aspects of interacting with the server system 120 (FIG. 1), including but not limited to:
   a browser application 224 for requesting information from the server system 120 (e.g., interactive excises) and receiving responses from the server system 120 especially when no dedicated application is installed on the client system 102 for communicating with the server system 120; and
   a dedicated application 226 associated with the server system 120 and specifically configured to send, receive, and display data from the server system 120 including interactive exercises and so on, and
client data module(s) 230 for storing data relevant to the clients, including but not limited to:

2 client profile data 232 for storing profile data related to a user (e.g., user 106) of the server system 120 associated with the client system 102.

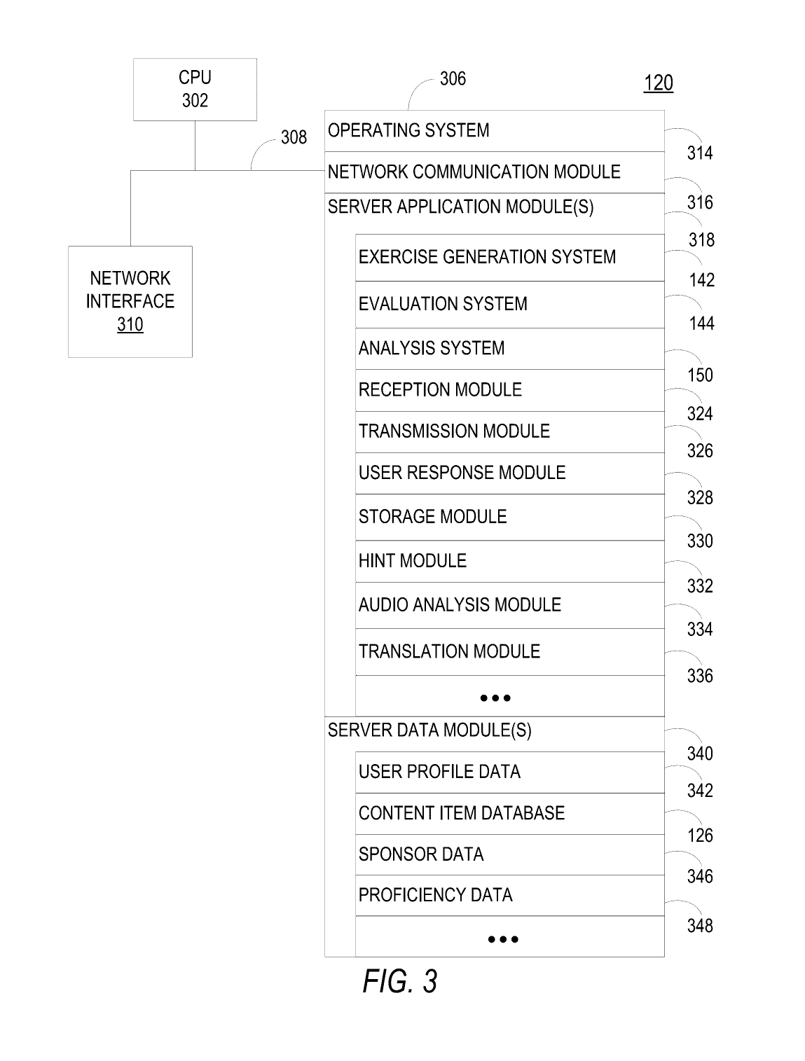

FIG. 3 is a block diagram further illustrating the server system 120, in accordance with some example embodiments. The server system 120 typically includes one or more CPUs 302, one or more network interfaces 310, memory 306, and one or more communication buses 308 for interconnecting these components. The memory 306 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternately the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the server system 120 to other computers via the one or more network interfaces 310 (wired or wireless) and one or more communication networks 104, such as the Internet, other WANs, LANs, MANs, and so on;
one or more server application modules 318 for performing the services offered by the server system 120, including but not limited to:
   an exercise generation system 142 for, when an interactive exercise is request, generating an interactive user exercise activity based on content stored in content item database 126 and information about the requesting user stored in the user profile data 342;
   an evaluation system 144 for receiving user feedback and comparing it against one or more stored predetermined acceptable responses;
   an analysis system 150 for determining, based on the received user response and the determination by the evaluation system 144 that the user has engaged with the sponsored content, whether the user correctly answered the interactive activity and whether the user has improved in responding to sponsored content from a particular sponsor over time (e.g., whether the user is more likely to correctly respond to an exercise now);
   a reception module 324 for receiving sponsored content items from sponsors, exercise requests from users, and exercise responses;
   a transmission module 326 for transmitting one or more generated interactive user exercises or activities to a client system (e.g., the client system 120 in FIG. 1);
   a user response module 328 for generating, accessing, or storing acceptable user responses to each of the various user exercises;
   a storage module 330 for storing user profile data 342, content item database 126, user proficiency data 348, and user response data;
   a hint module 332 for generating, determining, or accessing hints for interactive user exercises;
   an audio analysis module 334 for analyzing received user audio to extract text representing the user response data to a particular exercise; and
   a translation module 336 for converting sponsored messages into languages different than the original language; and
server data module(s) 340, storing data related to the server system 120, including but not limited to:
   user profile data 342, including both data provided by the user, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred user information based on user activity, social graph data, past history with interactive user applications, language proficiency, and so on;
   content item data 344 including all content used to generate user exercises including questions for trivia, words and sentences with the translations for a translation application, levels for a game, content to learn for a learning application, and so on;
   sponsor data 346 including data organizing sponsored content by a sponsor, recording user responses to the sponsored content, and sponsor goals and preferences; and
   proficiency data 348 for storing data about a user's proficiency with the interactive application including the number of levels passed (e.g., for a game), concepts the user has shown understanding of (e.g., for a learning application), and total user time spent with the interactive application.

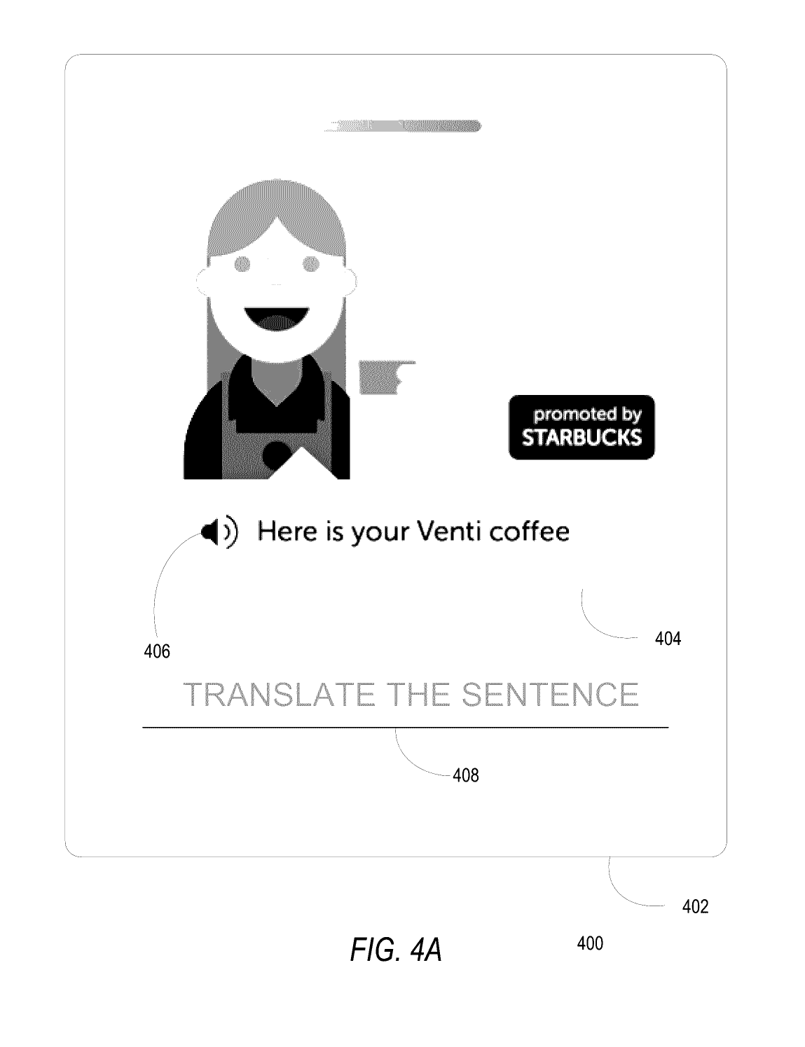

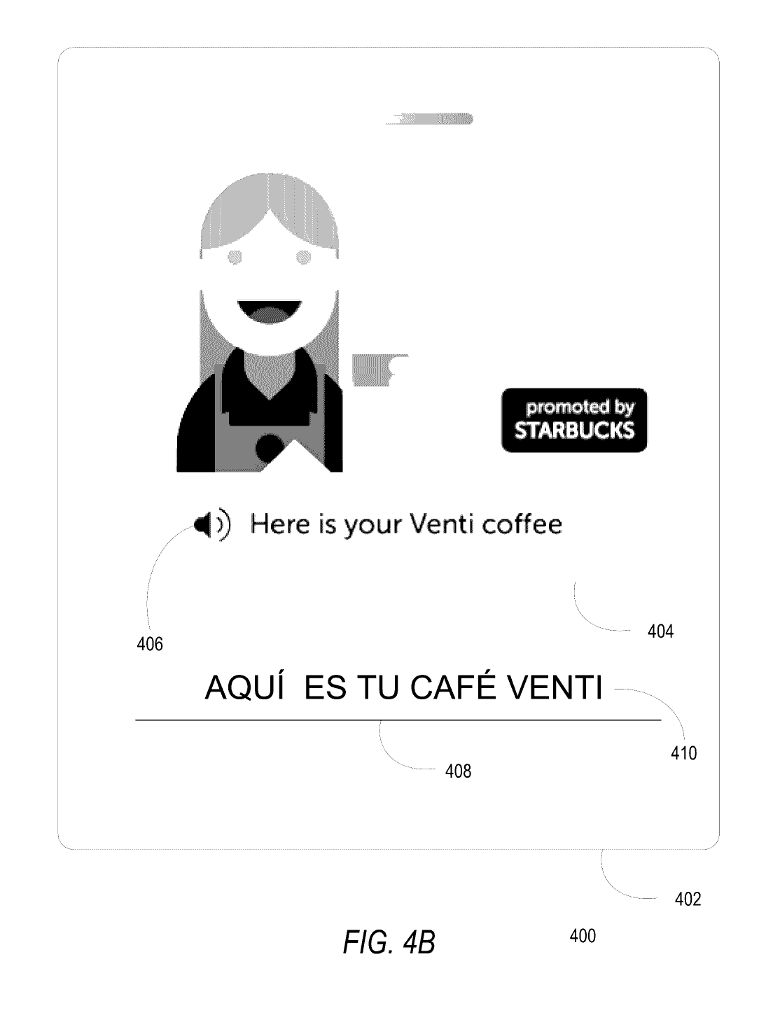

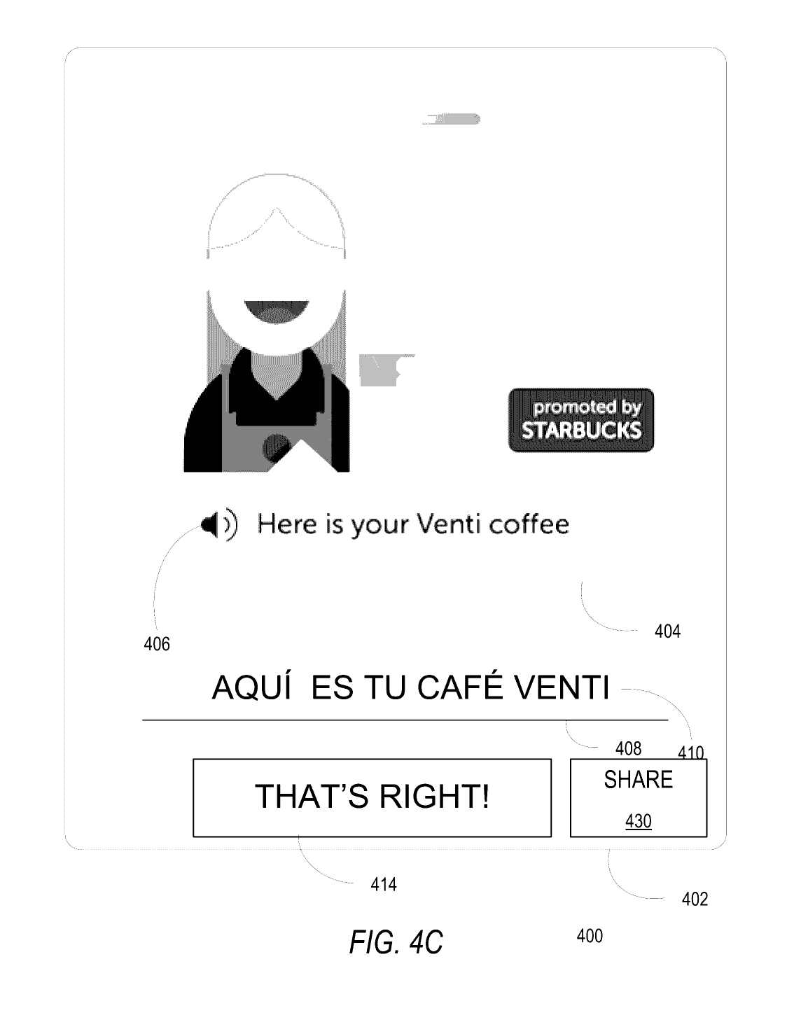

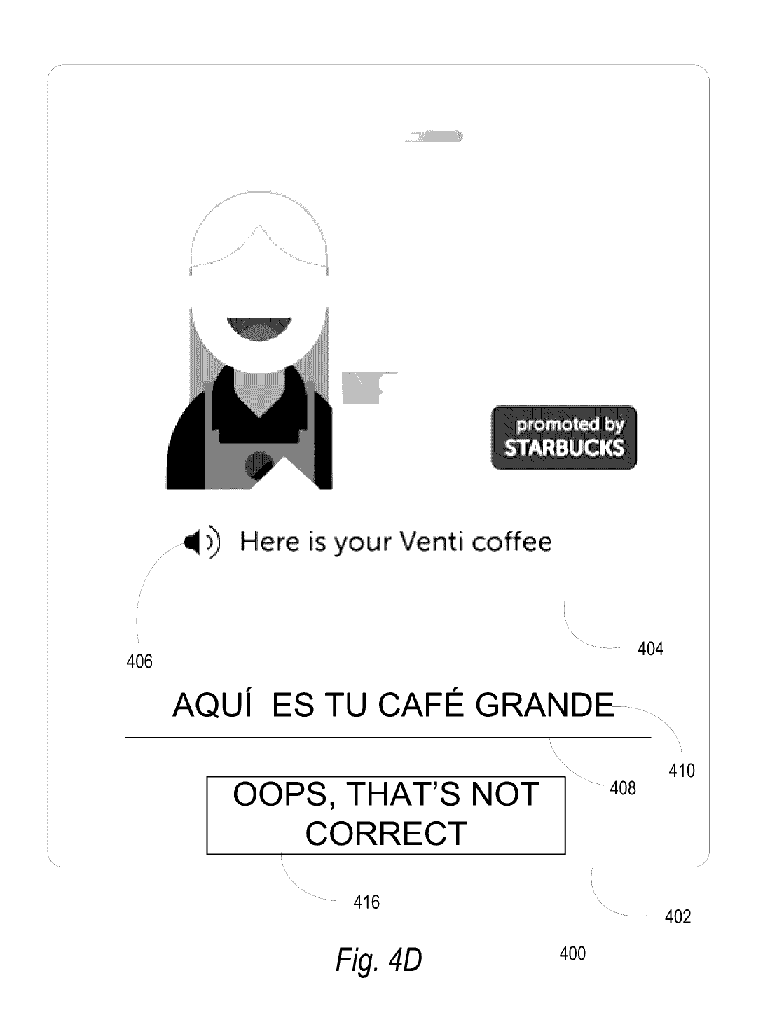

FIG. 4A illustrates an exemplary user interface 400 for an interactive language learning application associated with a server system (e.g., the server system 120 in FIG. 1). In this example the user interface 400 is displayed on a screen 402 (e.g., the screen of a personal computer, tablet computer, smartphone, or other electronic device). The user interface 400 for the language learning application includes an area in which translation exercises are displayed. In this example, a sentence 404 is displayed and the user interface 400 includes a user input field 408 that prompts the user to enter a translation for the displayed sentence 404.

In this example, the prompt includes the words “Translate the sentence” to clearly inform the user that the entire sentence 404 needs to be translated. In this case the sentence 404 is also a sponsored sentence 404. A sponsored sentence is a type of sponsored content wherein the sponsor chooses the sentence to be translated such that it increasing awareness of the sponsor's brand or a particular product produced by the sponsor. In some example embodiments, selecting the input field 408 will open a text input interface for entering text (e.g., on devices without a keyboard such as a smartphone).

The user interface 400 also includes a speaker icon 406 near the sponsored sentence 404. When selected (e.g., by mouse click or figure gesture) the application responds by presenting an audio version of the sentence 404. In some example embodiments, the sponsoring organization can select the audio such that a well-known spokesperson can be recorded saying the sentence 404.

FIG. 4B further illustrates the exemplary user interface 400 for an interactive language learning application associated with a server system (e.g., the server system 120 in FIG. 1). This figure continues on from FIG. 4A.

The user enters one or more characters into the user input field 408 in the language that the user is learning through the language learning application. In this case, the user is learning Spanish and enters a sentence that corresponds to the sentence (e.g., sentence 404) displayed as part of the exercise.

Once the user has completed their intended sentence, the user can trigger the client system (e.g., the client system 102 in FIG. 1) to send the entered user input to the server system (e.g., the server system 120 in FIG. 1).

FIG. 4C further illustrates the exemplary user interface 400 for an interactive language learning application associated with a server system (e.g., the server system 120 in FIG. 1). This figure continues on from FIGS. 4A-4B.

Once the user input has been transmitted from the client system (e.g., the client system 120 in FIG. 1) to the server system (e.g., the server system 120 in FIG. 1), the server system (e.g., the server system 120 in FIG. 1) sends a response to the client system indicating whether the user submitted an acceptable translation (e.g., the Spanish words entered 410 by the user).

The response from the server system (e.g., the server system 120 in FIG. 1) will indicate whether the submitted user input was acceptable. In this case, the server system (e.g., the server system 120 in FIG. 1) determines that the user-submitted input was correct or at least acceptable, causing the user interface 400 to display a feedback message 414 indicating success (e.g., in this case the message “That's Right!” is displayed.)

In some example embodiments, the response from the server system (e.g., the server system 120 in FIG. 1) cause the client system (e.g., the client system 102 in FIG. 1) to display a “Share” link 430. A “Share” link is a selectable button or link that enables the user, when the “Share” link is selected to share the sponsored message (or non-sponsored message) through a social media platform with which the user engages. In some example embodiments, the user selects the platform and logins to the appropriate platform prior to the sponsored exercise being shared.

FIG. 4D further illustrates the exemplary user interface 400 for an interactive language learning application associated with a server system (e.g., the server system 120 in FIG. 1). This figure continues on from FIGS. 4A-4C.

The response from the server system (e.g., the server system 120 in FIG. 1) can also indicate that the user input did not match any of the possible correct solutions. In this case, the user translated the sentence using “grande” rather than the more brand-specific “Venti.” In some example embodiments, the sponsor selects the specific translations that will be acceptable translations. In this way, branded terms that are important to the sponsored message will be represented in the acceptable translations. In some example embodiments, the user interface 400 will include hints provided by the sponsor to ensure the user knows which terms are considered branded content and will need to be included in the solution.

While many sponsored messages include either the name of the brand or the name of the product, some sponsored messages do not include either the brand name or the name of a product. Instead the sponsor message includes a message associated with a particular trait, component, or aspect of the brand or one of its products. For example, a shampoo brand (e.g., Lush) uses all natural organic ingredients and makes the quality of its ingredients a key aspect of its marketing. The sponsored message could then include information about the importance of organic ingredients in shampoo (“Do you have any shampoo with all natural ingredients?” In this way Lush's brand message is included without specifically including the brand name. When no product name or brand name is mentioned in the actual sponsored message, the exercise includes a trademark or a name identifying the sponsor of the exercise (e.g., located near or beside the sponsored content). In some example embodiments, a person is displayed

In this case, once the client system (e.g., the client device 102 in FIG. 1) receives a response (e.g., feedback message 414) from the server system (e.g., the server system 120 in FIG. 1) indicating the received user input does not match any of the acceptable solutions, the client system (e.g., the client device 102 in FIG. 1) displays a “Oops, that's not correct” message 416. In some cases (not shown here), the language learning application user interface 400 will include details on why the user input was incorrect (e.g., the term “grande” was used instead of “Venti”).

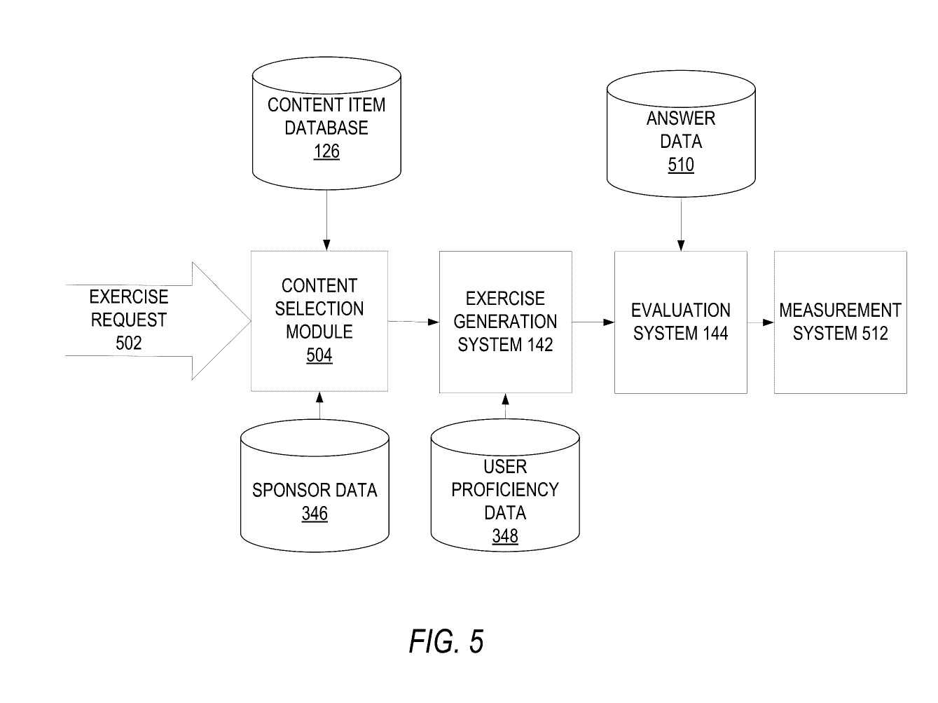

FIG. 5 is a block diagram demonstrating a module configuration, in accordance with some example embodiments, for generating a sponsored interactive user exercise and evaluating user responses.

The server system (e.g., the server system 120 in FIG. 1) receives an exercise request 502 from a client system (e.g., the client device 102 in FIG. 1). In some example embodiments, the exercise is generated when a user opens a dedicated application on their smartphone, tablet, or other computing device, and selects an option to initiate a new exercise.

The server system (e.g., the server system 120 in FIG. 1) uses the content selection module 504 to select appropriate content for the requesting user. For example, the exercise request 502 includes data identifying the requesting member and the content selection module 504 and the data stored in the content item database 134 to select appropriate content based on the characteristics of the user and the user's history. The content selection module 504 can also access the stored sponsor data 346 to determine whether the sponsor has particular specifications for which users should be presented with sponsored content. For example, a sponsor is located in a particular geographic region and only wants users who live in that geographic location to see the sponsored content or exercise.

In some example embodiments, the content item to be used is determined, and the server system (e.g., the server system 120 in FIG. 1) transmits the content item to the exercise generation system 142. In some example embodiments, a content item only lends itself to a single possible exercise such as, for example, if the content item is a single sentence that includes branded content that is integrated into language learning applications.

However, in some example embodiments, the content item is a topic or set of topics from which a variety of exercises can be generated. For example, a content item contains a series of facts about the TV show MASH. The exercise generation system 142 then uses the facts to generate one or more different trivia questions. In some example embodiments, the exercise generation system 142 uses user proficiency data 348 to determine the level of difficulty that is appropriate for an exercise for a particular user. In some example embodiments, the content selection module 504 uses the user proficiency data 348 to select content appropriate to the user's level. For example, in a language learning application the content selection module 504 or the exercise generation system 142 records what level of language mastery the user has achieved and then selects future content based on that.

In some example embodiments, once the exercise has been generated, it is transmitted to a client system (e.g., the client device 102 in FIG. 1) for presentation. In some example embodiments, the exercise can be text, video, audio, computer generated images, and so on. For example, a trivia quiz or translation exercise can be read in audio format to a user.

In some example embodiments, when the exercise is presented to the user, the user is prompted to enter a user response or solution to the exercise. For example, in a language learning application, the user is presented with a word or phrase and is prompted to provide a translation of the word or phrase from a first language to a second language.

In some example embodiments, the evaluation system 144 receives the user response (e.g., the user solution) to the generated exercise. The evaluation system 144 then compares the user response to the answer data 510. In some example embodiments, the answer data 510 is generated by the exercise generation system 142 when the exercise is created. In other example embodiments, the answer data 510 is created by the sponsors when the sponsored content item or data is sent to the server system (e.g., the server system 120 in FIG. 1). In this way the sponsor can determine how their content is to be best used by the server system 120.

The measurement system 512 may then generate overall data concerning how well users do on particular exercises and generate data on whether users are engaging effectively with branded content. For example, the measurement system 512 determines whether users have correctly responded to a branded exercise (e.g., a translation exercise is completed correctly). In other example embodiments, the measurement system 512 follows user progress over time through multiple exercise from the same sponsor to determine if the user is increasingly familiar with the sponsor's brands and/or products. In other example embodiments, the measurement system 512 uses surveys to track user engagement and awareness.

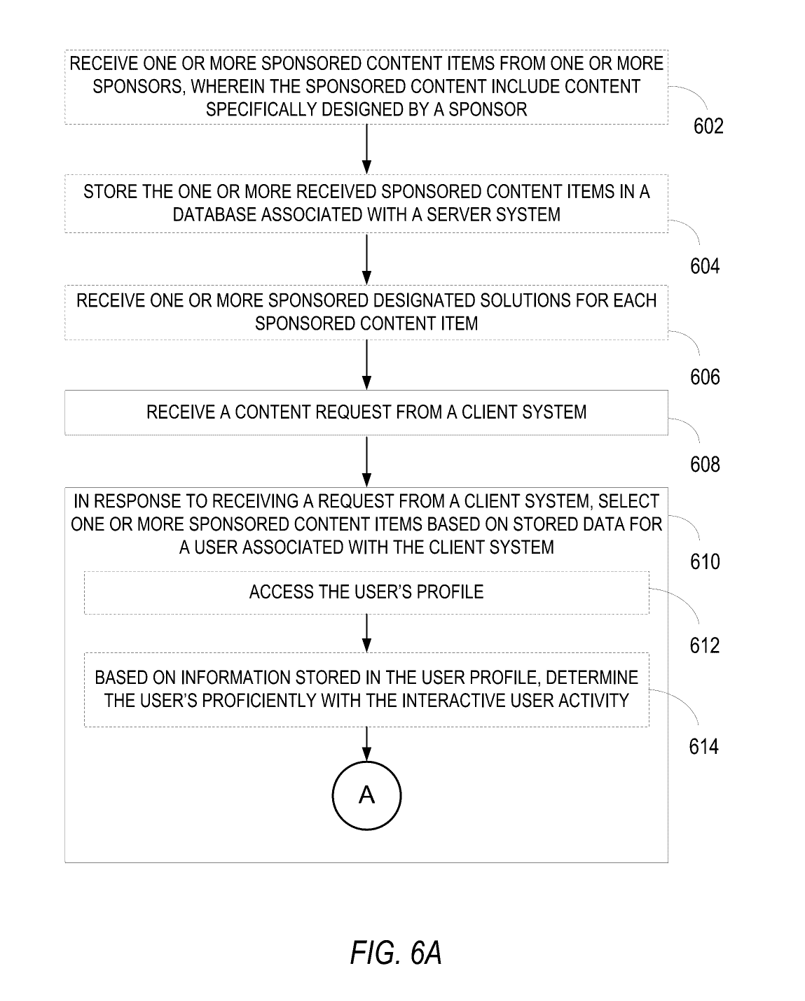

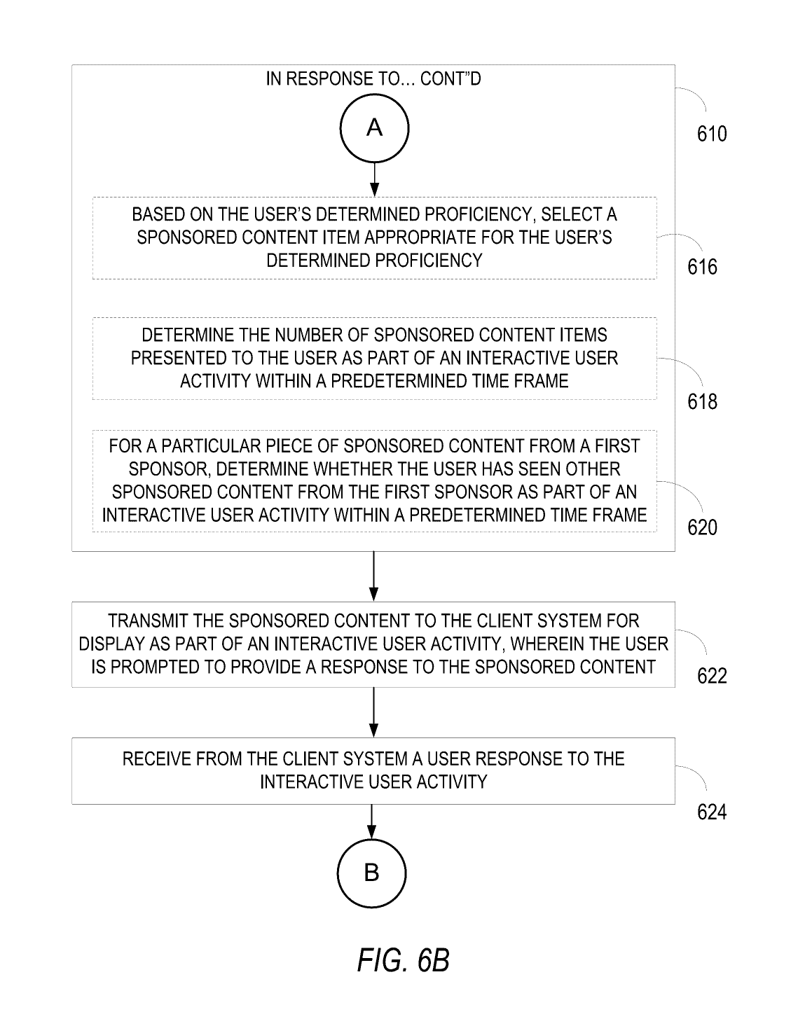

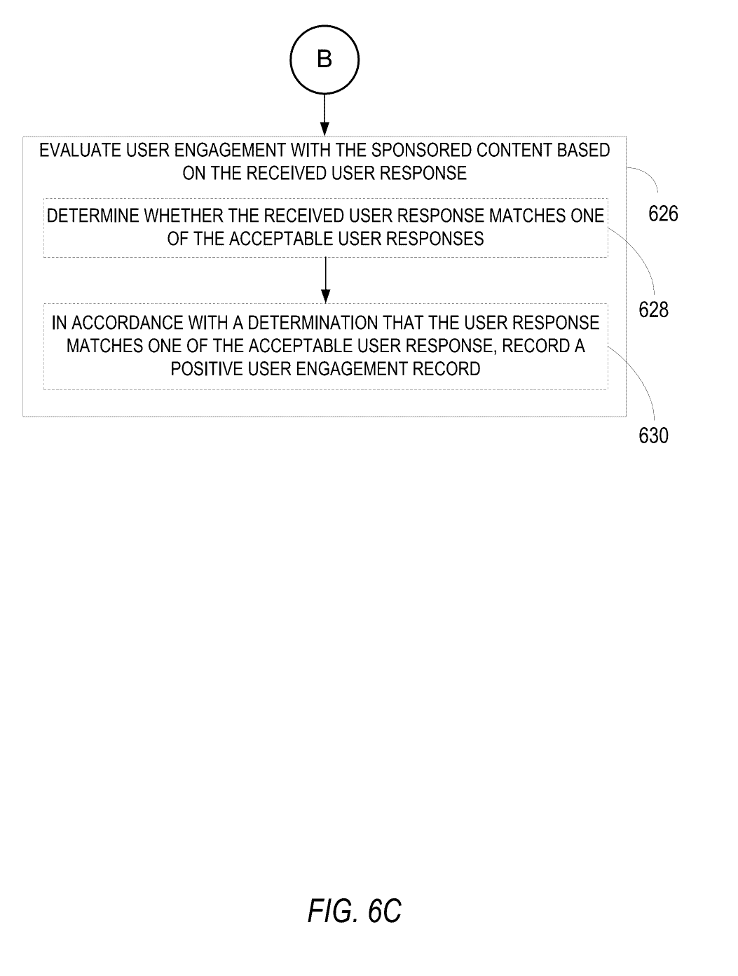

FIG. 6A is a flow diagram illustrating a method, in accordance with some example embodiments, for generating and presenting interactive user activities that include sponsored content. Each of the operations shown in FIG. 6A may correspond to instructions stored in a computer memory or computer-readable storage medium. Optional operations are indicated by dashed lines (e.g., boxes with dashed-line borders). In some embodiments, the method described in FIG. 6A is performed by the server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

The server system (e.g., the server system 120 in FIG. 1) receives (602) one or more sponsored content items from one or more sponsors, wherein the sponsored content includes content specifically designed by a sponsor. Note that content designed or created by a sponsor is different than content that is merely branded with a logo or trademark of a sponsor. For example, showing a video with an advertisement beside it is not the same as showing a video that was designed by the sponsor and that includes sponsored messages as an integral part of the video. In another example, a quiz game that involves trivia questions introduces sponsored questions by having the sponsor submit or suggest specific user level appropriate trivia questions that are associated with the sponsors brand or products.

In some example embodiments, the server system (e.g., the server system 120 in FIG. 1) creates a platform accessible to an interested sponsor for buying and managing sponsored activities. In some example embodiments, each sponsor request would be dealt with manually (e.g., an employee would receive the request, created the sponsored activity based on the details included in the request, and insert the newly created sponsored activity into interactive user application to be presented to users).

In other example embodiments, the server system (e.g., the server system 120 in FIG. 1) provides an exercise creation platform that sponsors can access such that the sponsor can provide information necessary for an interactive exercise, design the exercise, pay for cost to have the sponsored message displayed, establish the target demographics, and so on. In this way, the sponsor can prepare a sponsored exercise and have it go live in an interactive application without the server system (e.g., the server system 120 in FIG. 1) manually implementing each exercise. In this way a large number of sponsors can simultaneously create and launch sponsored messages even when no live person from the server system (e.g., the server system 120 in FIG. 1) is available. In some example embodiments, the sponsors can use the sponsored message to platforms bid competitively on the pricing of sponsored messages. In some example embodiments, bids would be segmented by user demographics (e.g., age, location, language) and by type of interactive application (games, learning, and so on).

In some example embodiments, the server system (e.g., the server system 120 in FIG. 1) integrates or allows integration from a third-party advertisement platform (e.g., Google AdSense) and would receive sponsored messages at particular prices (e.g., negotiated with the third-party advertisement platform).

In some example embodiments, the sponsored message platform also includes an interface for an advertiser to provide content for sponsored exercises (e.g., sentences, characters, feedback on brand messaging, and so on). A self-service interface includes tools to help the brand create sentences which will have the maximum positive impact on users of the server system (e.g., the server system 120 in FIG. 1). For example, the interface includes a character gallery, and a character builder, which would let sponsors create human characters that fit specific design guidelines of the server system (e.g., the server system 120 in FIG. 1) while meeting the marketing goals of the sponsor.

A content item includes any type of media item that can be present by an electronic device. Thus, sponsored content items can include text-based content items, video content items, audio content items, and so on. In some examples, a language learning application uses cartoon characters to present sentences for translation by the user.

In some example embodiments, the sponsor can create a custom character (e.g., one that reflects the brand or the values of the brand). However, if the sponsor does not supply a specific custom character, the server system (e.g., the server system 120 in FIG. 1) can generate a character based on information from the sponsor (e.g., the sponsor can suggest attributes such as female, happy, and so on) or based on information about the brand (e.g., the brand is for young urbanites). In some example embodiments, the server system (e.g., the server system 120 in FIG. 1) can infer, based on the word choice of the sponsored content, characteristics of the character (e.g., the grammar of a sponsored sentence indicates that the speaker should be male).

In some example embodiments, the server system (e.g., the server system 120 in FIG. 1) stores (604) the one or more received sponsored content items in a database associated with a server system. This information is then readily accessible to the server system (e.g., the server system 120 in FIG. 1) when determining the exercise to send to a particular user.

Each content item, whether sponsored or not, is used to generate interactive user activities. Each interactive user activity includes an exercise to which the user provides a response. Exercises can be designed in many different versions. For example, a language learning application includes exercises to translate a sponsored sentence from a first language to a second language, an exercise to translate a sponsored sentence from a second language to a first language, an exercise to repeat a sponsored sentence in the language not native to the user, an exercise to translate a sponsored sentence from a user's native language to language being learned and then spoken by the user, an exercise to match pairs of words in a first language and a second language, an exercise to fill in a word to complete a sentence, an exercise requiring the user to identify a picture that matches a word or phrase in the language being learned, an exercise that requires a user to enact an action described in the language being learned (e.g. “drink the soda” could involve dragging a picture of a can of Coke to a picture of a mouth), and a question and answer exercise requiring a user to respond to questions in the language being learned (e.g. a user who is learning English may be asked “What do you want to eat?”, and as a prompt they see a box of Dominos pizza and would respond in a way that referenced the pizza pictured).

In some example embodiments, the server system (e.g., the server system 120 in FIG. 1) implements multiplayer exercises. Such exercise enables users to interact with each other while learning a second language. For example, users could play a game wherein a first user is shown an image, and must use the new language to describe it to the second user. The second user then has to guess the image that the first user is shown.

To judge the response for correctness, each content has one or more associated acceptable answers. For example, in a language learning translation application, the server system (e.g., the server system 120 in FIG. 1) compares the received translation against the list of acceptable translations.

In some example embodiments, the server system (e.g., the server system 120 in FIG. 1) receives (606) one or more sponsored designated solutions for each sponsored content item. Thus the sponsor can determine which solutions (e.g., correct responses) are acceptable. In some example embodiments, the sponsored content items include text in a first language and the one or more sponsored designation solutions include text in a second language.

In some example embodiments, the server system (e.g., the server system 120 in FIG. 1) receives (608) a content request from a client system (e.g., the client device 102 in FIG. 1). A client device 102 is a computer system associated with a user seeking to access one or more interactive user activities. The user (using an application on the client device 102) initiates the sending of a request to the server system (e.g., the server system 120 in FIG. 1). In some example embodiments, the request identifies the user associated with the client system and specifies a type of exercise or a specific exercise.

In response to receiving a request from a client system, server system (e.g., the server system 120 in FIG. 1) selects (610) one or more sponsored content items based on stored data for a user associated with the client system.

To select one or more sponsored content items the server system (e.g., the server system 120 in FIG. 1) accesses (612) a user's profile. The user profiles are stored in a database at the server system (e.g., the server system 120 in FIG. 1). The user profiles include the users past history with the application associated with the server system (e.g., the server system 120 in FIG. 1). For example, if the server system is associated with a game, the user profile tracks the user's progress through the game as well as any statistics that represent the user's ability to play the game.

Based on information stored in the user profile, the server system (e.g., the server system 120 in FIG. 1) determines (614) the user's proficiency with the interactive user activity. For example, if the interactive user activity is a language learning activity, the server system (e.g., the server system 120 in FIG. 1) accesses the user's profile to determine what concepts (e.g., grammatical concepts) and words the user is familiar with. In some example embodiments, the user profile stores the results of past exercises. By reviewing which exercises the user is able to consistently perform correctly, the server system (e.g., the server system 120 in FIG. 1) can estimate the user's current proficiency.

FIG. 6B is a flow diagram illustrating a method, in accordance with some example embodiments, for generating and presenting interactive user activities that include sponsored content. Each of the operations shown in FIG. 6B may correspond to instructions stored in a computer memory or computer-readable storage medium. Optional operations are indicated by dashed lines (e.g., boxes with dashed-line borders). In some embodiments, the method described in FIG. 6B is performed by the server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

Based on the user's determined proficiency, the server system (e.g., the server system 120 in FIG. 1) selects (616) a sponsored content item appropriate for the user's determined proficiency. Thus, if a sponsor has supplied more than one sponsored message, with each sponsored message appropriate for a different proficiency level of user, the server system 120 can select the sponsored message closest to the level of proficiency of the target user. The server system (e.g., the server system 120 in FIG. 1) then selects the appropriate level of sponsored message based on the user's determined proficiency.

In some example embodiments, the server system (e.g., the server system 120 in FIG. 1) determines (618) the number of sponsored content items presented to the user as part of an interactive user activity within a predetermined time frame. Thus, if a user has received a large number of sponsored activities within a predetermined amount of time (e.g., a week), the server system is less likely to select further sponsored content for that user.

For a particular piece of sponsored content from a first sponsor, the server system (e.g., the server system 120 in FIG. 1) determines (620) whether the user has seen other sponsored content from the first sponsor as part of an interactive user activity within a predetermined time frame. Thus, if a series of sponsored content items from a single sponsor are intended to be displayed as a group, the server system (e.g., the server system 120 in FIG. 1) may be more likely to select the rest of the sponsored content group for a user that has already seen some of the other content items in the group.

In other example embodiments, if the server system (e.g., the server system 120 in FIG. 1) determines that a user has not seen too many sponsored content items in general, but that all the sponsored content items they have seen are from a single sponsor, the server system (e.g., the server system 120 in FIG. 1) may intentionally select sponsored content from another sponsor or not select sponsored content at all.

In some example embodiments, the server system (e.g., the server system 120 in FIG. 1) also considers users' success rates on previous sponsored exercises. For example, a user that has very low success rate may be less likely to be selected for future sponsored content. Conversely, a user with a low success rate may be selected more often to help the user improve.

In some example embodiments, the server system (e.g., the server system 120 in FIG. 1) uses the user's demographic information, (e.g., age, gender, location, language being learned, native language, reason for learning, device, and so on) to select appropriate user content.

The server system (e.g., the server system 120 in FIG. 1) transmits (622) the sponsored content to the client system for display as part of an interactive user activity, wherein the user is prompted to provide a response to the sponsored content. As noted above, the interactive user activity can include a game, a learning application, a translation application, and so on.

In some example embodiments, the server system (e.g., the server system 120 in FIG. 1) also transmits a share link with the sponsored activity. In some example embodiments, the share link is a selectable link that, when selected (e.g., clicking, touching on a touch-screen, and so on), causes the sponsored activity to be shared on social media (e.g., Twitter, Facebook, Instagram, and so on).

In some example embodiments, the server system (e.g., the server system 120 in FIG. 1) generates the interactive user activity (also known as an exercise) using the selected content item. In some example embodiments, the interactive user activity is a translation exercise for a language learning application. For example, the translation activity presents a word or phrase in a first language and the user responds with the phrase translated into a second language, either by typing in the translation, speaking the translation, or selecting the translation from one or more translation options. In other example embodiments, a word or phrase is presented and a series of images, sounds, or videos are presented. The user then selects one of the displayed images, sounds, or videos.

In some example embodiments, the interactive user exercise is one of a translation exercise, a verbal repetition exercise, a verbal translation exercise; a word matching exercise, a fill-in-the-blank exercise, action replication exercise, and a question and answer exercise. A translation exercise is an exercise wherein the user is presented with a word or sentence in a first language (either the user's native language or the language the user is learning) is expected to input text of the appropriate translated text in a second language (e.g., the second language is the user's native language if the first language was the language the user was learning and the second language is the language the user is learning if the first language was the user's native language.)

A verbal repetition exercise is an exercise that requires the user to repeat a word or sentence that is played to them (e.g., presented in an audio format). For example, this exercise might be used to evaluate a user's pronunciation of words or phrases in a language they are learning.

A verbal translation exercise is an exercise in which a user is presented with a word or phrase in a first language and must translate the sentence and speak the translated word or phrase into a speaker for evaluation by the server system (e.g., the server system 120 in FIG. 1).

A word matching exercise is an exercise in which a plurality of words and phrases are displayed to a user in more than one language (e.g., the user's native language and the language the use is learning). The user then selects a word (or phrase) from a first language and then selects a matching word (or phrase) from a second language.

A fill-in-the blank exercise is an exercise in which a sentence with one or more missing words is presented to the user. The user then uses a drop down menu associated with each missing word to select the appropriate word to fill in the blank (e.g., from a list of potential words).

An action replication exercise is an exercise in which a user enacts an action described by a prompt. In some example embodiments, the client system captures live motion from the user with a motion capture device. In other example embodiments, the user enacts the described motion through interaction with the client system (e.g., the client system 102 in FIG. 1) (e.g. “drink the soda” could involve dragging a picture of a can of Coke to a picture of a mouth).

A question and answer exercise is an exercise in which the user is presented which a question (either in the user's native or preferred language or in the language which the user is trying to learn) and the user is then prompted to provide an answer (e.g., usually in the language is trying to learn or the user's native language). For example, a user is asked “What do you want to eat?”, and as a prompt a box of Dominos pizza is presented. A correct response (if the user was learning English) would be to respond in English with “I want to eat pizza”, or even “I want to eat some Domino's).

In some example embodiments, the interactive user exercise is a multiplayer interactive user exercise. The multiplayer interactive user exercise includes transmitting a first image to a first user (e.g., a photo of a banana). The user is then prompted to provide a description of the first image without using the specific word for the image (e.g., without using the word “banana.” The server system (e.g., the server system 120 in FIG. 1) receives, from the first user, a description of the first image in a learning language.

The server system (e.g., the server system 120 in FIG. 1) transmits the description of the first image (received from the first user) to a second user. The server system (e.g., the server system 120 in FIG. 1) also transmits a plurality of images including the first image to the second user. For example, the second user receives five different images of fruit, one of which is a banana. The user then decides, based on the received description, which image is being described and selects that image.

Server system (e.g., the server system 120 in FIG. 1) receives, from the second user, a user response selecting one of the plurality of images as the image described by the transmitted description.

In some example embodiments, each interactive user activity has one or more acceptable user response and each interactive user activity has one or more hints. For example, in a translation exercise, the hints include help for the user to correctly translate the word or sentence at issue.

In some example embodiments, the one or more hints for an interactive user activity that includes sponsored content are supplied by the sponsor. In this way, the hints reflect the intended message of the sponsor.

The server system (e.g., the server system 120 in FIG. 1) receives (624) from the client system a user response to the interactive user activity. In some example embodiments, the user response is recorded at the client system (e.g., the client device 102 in FIG. 1) and transmitted to the server system (e.g., the server system 120 in FIG. 1) when the user indicates that he or she has completed the exercise.

In some example embodiments, the user response is stored in one of a text file, a video file, and an audio file, depending on how the user entered their response. For example, a user can record a video of themselves answering a geography question for a geography learning exercise. This video is then sent to the server system (e.g., the server system 120 in FIG. 1).

FIG. 6C is a flow diagram illustrating a method, in accordance with some example embodiments, for generating and presenting interactive user activities that include sponsored content. Each of the operations shown in FIG. 6C may correspond to instructions stored in a computer memory or computer-readable storage medium. Optional operations are indicated by dashed lines (e.g., boxes with dashed-line borders). In some embodiments, the method described in FIG. 6C is performed by the server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

Once the user response has been received, the server system (e.g., the server system 120 in FIG. 1) evaluates (626) user engagement with the sponsored content based on the received user response.

In some example embodiments, evaluating user engagement with the sponsored content based on the received user response includes the server system (e.g., the server system 120 in FIG. 1) determining (628) whether the received user response matches one of the acceptable user responses. In accordance with a determination that the user response matches one of the acceptable user responses, the server system (e.g., the server system 120 in FIG. 1) records (630) a positive user engagement record. This determination may be made using software designed for that purpose. An example of possible pseudocode is presented below.

| | |
|---|---|
| // | Returns a grade for the user's input |
| // | |
| // | CORRECT_ANSWER: User sees “you're right” |
| // | TYPO_ANSWER: User sees “Almost”, but gets marked |
| // | right, and sees highlighting of what was wrong |
| // | NO_MATCH with highlights: User sees “incorrect” and |
| // | is shown how their answer differs from an |
| // | acceptable translation |
| // | NO_MATCH with nil/nil: User sees “incorrect” and |
| // | the best solution without any highlights on |
| // | the difference from their provided answer |
| // | |

function gradeUserResponse(user_solution,

| | |
|---|---|
| | compact_solution) { |
| | get list of all_solutions from the compact_solution; |
| | set min_edit_distance to maximum int; |
| | set closest_translation to “”; |
| | set highlights to [ ]; |
| | for solution in all_solutions { |
| | get blame for comparison of solution |
| | and user_solution; |
| | if blame is CORRECT { |
| | return CORRECT_ANSWER, solution, highlights; |
| | } |
| | if blame is TYPO { |
| | set highlights to indices of typos; |
| | return TYPO_ANSWER, solution, highlights; |
| | } |
| | get edit_distance between solution and |
| | user_solution; |
| | if edit_distance < min_edit_distance { |
| | set highlights to indices of differences |
| | between solution and user_solution; |
| | set min_edit_distance to edit_distance; |
| | set closest_translation to solution; |
| | } |
| | } |
| | if min_edit_distance < edit_distance_threshold { |
| | return NO_MATCH, closest_translation, highlights; |
| | } else { |
| | return NO_MATCH, nil, nil; |
| | } |
| } | |

As can be seen above, in one example, the server system (e.g., the server system 120 in FIG. 1) receives both the user solution and a compact solution. The compact solution includes data representing all possible correct responses in a compact or compressed form (or includes a reference to where the solutions are stored). Using the compact solution the server system 120 accesses all approved solutions. The server system 120 then determines whether the received answer matches any of the approved solutions. If so, the received solution is determined to be correct.

In not, the server system 120 determines the edit distance between the user solution and the approved solution. The server system 120 determines the approved solution with the smallest edit distance from the user answer (e.g., edit distance representing the difference between two strings). The server system 120 selects the closest translation (e.g., the approved solution with the smallest edit distance from the user solution) and determines whether the edit distance exceeds a maximum allowable edit distance. In some example embodiments, the maximum allowable edit distance is determined on a case by case basis such that each user activity has a customized maximum allowable edit distance (e.g., certain questions may need wider allowable edit distance). In other example embodiments, the maximum allowable edit distance is predetermined and constant for all exercises.

In some example embodiments, if the user solution determined to be within the maximum acceptable edit distance the server system 120 determines the user solution is correct. If not, the user solution is determined to be incorrect.

In some example embodiments, the server system (e.g., the server system 120 in FIG. 1) adjusts a user's overall progress based on whether they correctly respond to an interactive user activity. However, in some cases, incorrectly answering a sponsored content item is not used to evaluate the user's progress.

In some example embodiments, the server system (e.g., the server system 120 in FIG. 1) measures the success rate of the sponsored exercise based on the percentage of times that a user successfully completed the exercise.

In some example embodiments, the server system (e.g., the server system 120 in FIG. 1) measures the impact of the sponsored exercises on the system as a whole. For example, the server system (e.g., the server system 120 in FIG. 1) can measure the number of exercises completed each day to determine whether the overall rate is increasing or decreasing in response to the introduction of certain sponsored messages. The server system (e.g., the server system 120 in FIG. 1) can also measure total number of users, the number of users per day, the number of logins per day, and so on.

In some example embodiments, the server system (e.g., the server system 120 in FIG. 1) can measure the effectiveness of the sponsored messages through follow-up user surveys with a partial group of users. The surveys can measure change in awareness, favorability or purchase intent for the brand and/or its products.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) specifically tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, user interfaces, applications and so forth described in conjunction with FIGS. 4-6C are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

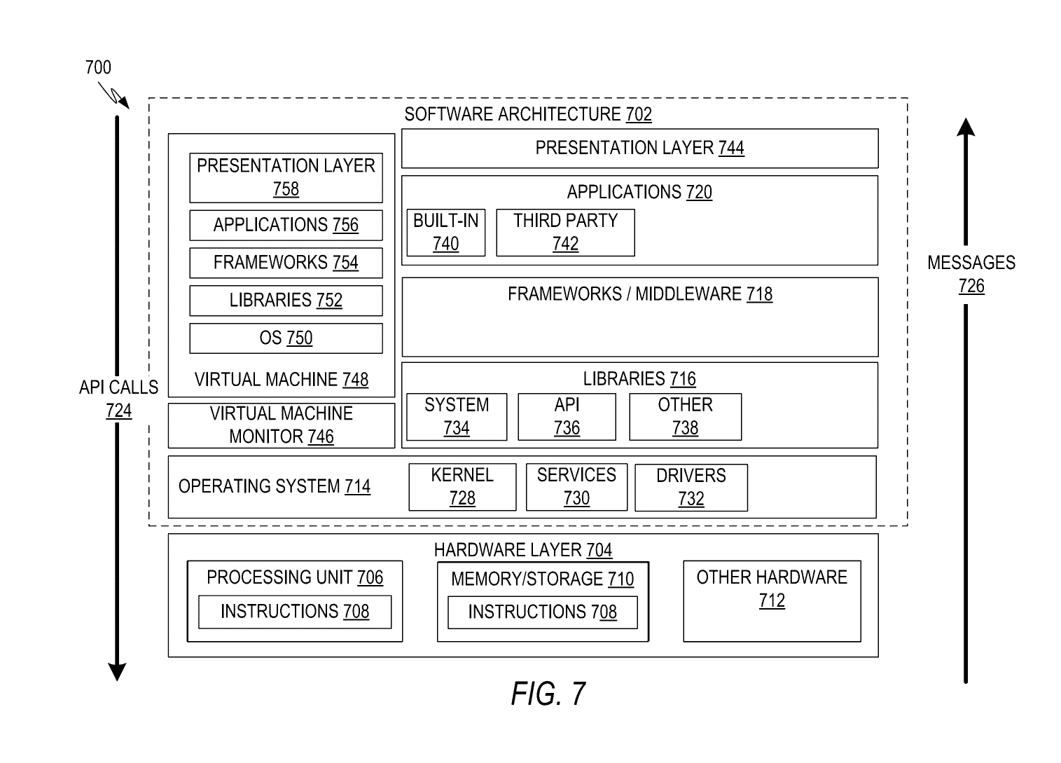

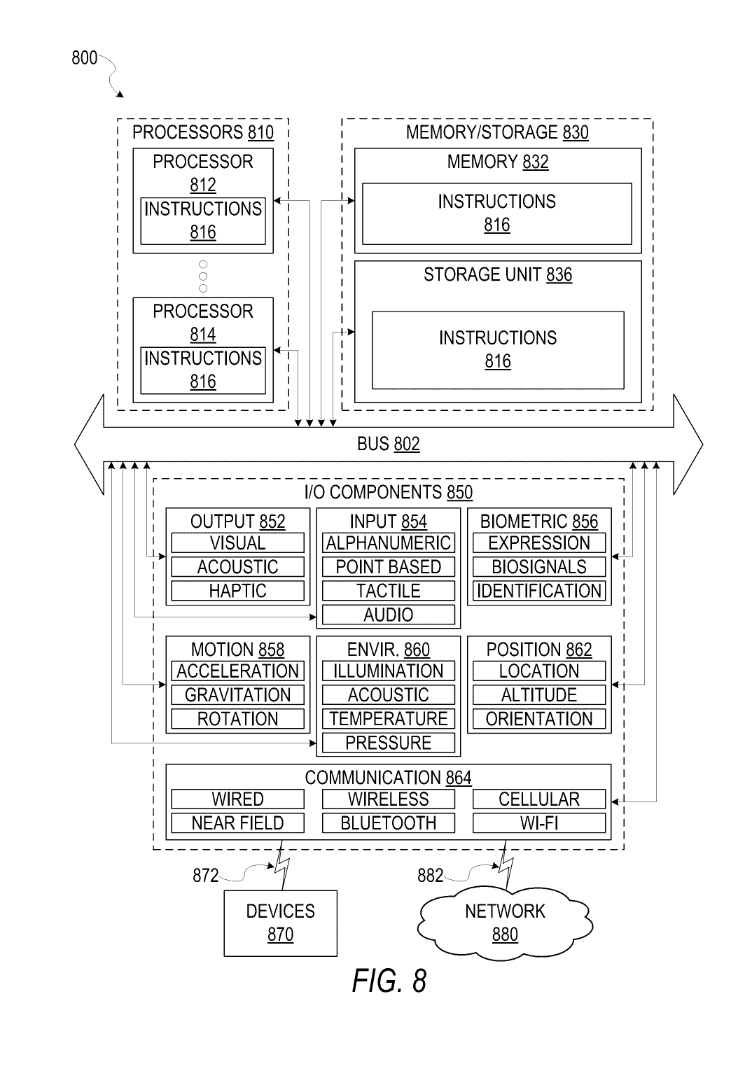

FIG. 7 is a block diagram 700 illustrating a representative software architecture 702, which may be used in conjunction with various hardware architectures herein described. FIG. 7 is merely a non-limiting example of a software architecture 702 and it will be appreciated that many other architectures may be implemented to facilitate the functionality described herein. The software architecture 702 may be executing on hardware such as a machine 800 of FIG. 8 that includes, among other things, processors 810, memory/storage 830, and I/O components 850. A representative hardware layer 704 is illustrated in FIG. 7 and can represent, for example, the machine 800 of FIG. 8. The representative hardware layer 704 comprises one or more processing units 706 having associated executable instructions 708. The executable instructions 708 represent the executable instructions of the software architecture 702, including implementation of the methods, modules, and so forth of FIGS. 4-7. The hardware layer 704 also includes memory and/or storage modules 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and a presentation layer 744. Operationally, the applications 720 and/or other components within the layers may invoke application programming interface (API) calls 724 through the software stack and receive a response, returned values, and so forth, illustrated as messages 726, in response to the API calls 724. The layers illustrated are representative in nature and not all software architectures have all layers. For example, some mobile or special purpose operating systems may not provide a frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730, and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware 718 may provide a higher-level common infrastructure that may be utilized by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third party applications 742. Examples of representative built-in applications 740 may include, but are not limited to, a contacts application, a browser application, a book reader application, a location application, a media application, a messaging application, and/or a game application. The third party applications 742 may include any of the built in applications 740 as well as a broad assortment of other applications. In a specific example, the third party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 742 may invoke the API calls 724 provided by the mobile operating system such as the operating system 714 to facilitate functionality described herein.

The applications 720 may utilize built-in operating system functions (e.g., kernel 728, services 730, and/or drivers 732), libraries (e.g., system libraries 734, API libraries 736, and other libraries 738), and frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures utilize virtual machines. In the example of FIG. 7, this is illustrated by a virtual machine 748. A virtual machine creates a software environment where applications/modules can execute as if they were executing on a hardware machine (such as the machine of FIG. 8, for example). A virtual machine 748 is hosted by a host operating system (e.g., operating system 714 in FIG. 7) and typically, although not always, has a virtual machine monitor 746, which manages the operation of the virtual machine 748 as well as the interface with the host operating system (e.g., operating system 714). A software architecture executes within the virtual machine 748 such as an operating system 750, libraries 752, frameworks 754, applications 756, and/or presentation layer 758. These layers of software architecture executing within the virtual machine 748 can be the same as corresponding layers previously described or may be different.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the flow diagrams of FIGS. 5-6. The instructions 816 transform the general, non-programmed machine 800 into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory/storage 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include a multi-core processor that may comprise two or more independent processors (sometimes referred to as “cores”) that may execute the instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and the memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

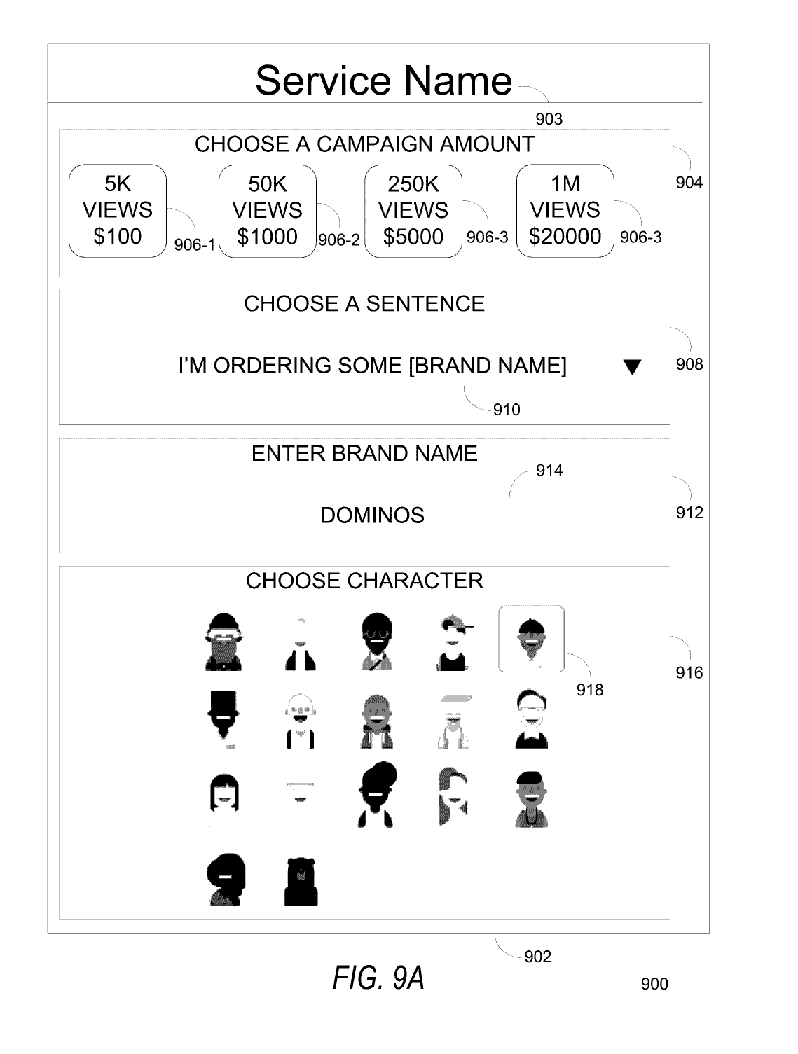

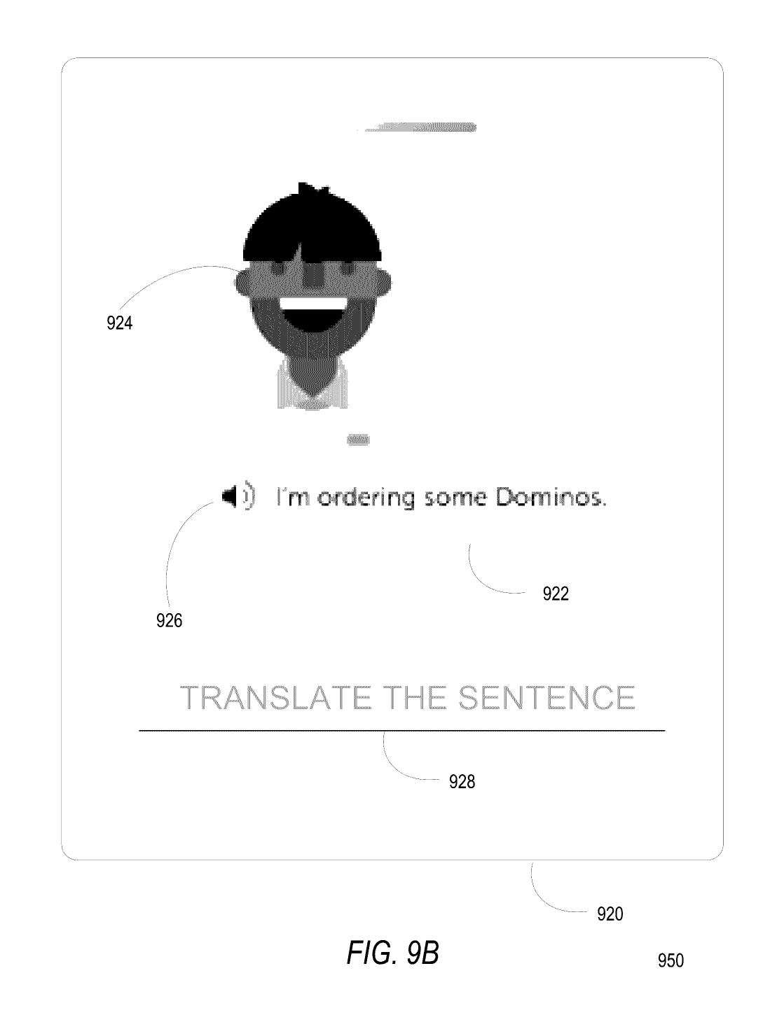

FIG. 9A illustrates an exemplary user interface 900 for a sponsored exercise creation platform associated with a server system (e.g., the server system 120 in FIG. 1). In this example the user interface 400 is displayed on a screen 902 (e.g., the screen of a personal computer, tablet computer, smartphone, or other electronic device). The user interface 900 for the sponsored exercise creation platform includes the name 903 of the service associated with an interactive application (e.g., the brand name of the website or application)

In this example, the user interface 900 includes a series of input fields allowing a potential sponsor to select the sponsor plan that most closely matches their objectives. The user interface 900 includes a campaign amount selection area 904. The campaign amount selection area 904 includes a series of amount selection options (906-1 to 906-4), each representing a varying amount of cost and exposure. The sponsor selects the amount of money/exposure by selecting one of the options.

In some example embodiments, the user interface 900 includes a sponsored content selection area 908. The sponsored content selection area 908 includes an input field 910 allowing the sponsor to choose a specific sponsored message. In this example, the sponsor choose one of a plurality of possible sponsored messages from a dropdown menu. In other example embodiments, the sponsors enters text themselves (and provides the appropriate translations and hints as necessary).

The user interface 900 also includes a sponsor identification area 912. The sponsor identification area 912 includes a text entry area 914 for entering the name of the sponsor or brand name the sponsor chooses. The user interface 900 includes a character creation area 916. The character creation area 916 includes a series of potential characters the sponsor can choose to include in the sponsored message (e.g., the character from whom the message is presented). The sponsor selects one of the available characters 918. In some example embodiments, the sponsor can supply their own character.

FIG. 9B illustrates an exemplary user interface 950 for an interactive language learning application associated with a server system (e.g., the server system 120 in FIG. 1) and automatically generated based on information entered by a sponsor in the sponsored exercise creation platform shown in FIG. 9A. In this example the user interface 950 is displayed on a screen 920 (e.g., the screen of a personal computer, tablet computer, smartphone, or other electronic device). The user interface 950 for the language learning application includes an area in which translation exercises are displayed. In this example, a sentence 922 is displayed and the user interface 950 includes a user input field 922 that prompts the user to enter a translation for the displayed sentence 922.

This example also includes a character 924 that is associated with the sponsored content. Thus, the sentence 922 and the character 924 were selected by the sponsor.

The user interface 952 also includes a speaker icon 926 near the sponsored sentence 922. When selected (e.g., by mouse click or figure gesture) the application responds by presenting an audio version of the sentence 922. In some example embodiments, the sponsoring organization can select the audio such that a well-known spokesperson can be recorded saying the sentence 922. In some example embodiments, the audio version is also provided by the sponsor.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a content request from a client system;
in response to receiving the content request from the client system, selecting a sponsored content item for a user associated with the client system, wherein the sponsored content items were associated with one or more sponsors of an interactive user application;
communicating the sponsored content item to the client system for display as part of an interactive user exercise, wherein the user is prompted to provide a response to the sponsored content item;
receiving, from the client system, a user response to the interactive user exercise; and
evaluating user engagement with the sponsored content items based on the received user response.

2. The method of claim 1, wherein the interactive user exercise is a translation exercise for a language learning application.

3. The method of claim 2, wherein the interactive user exercise presents the selected sponsored content item in a first language and the user response is in a second language.

4. The method of claim 1, further comprising:
receiving one or more sponsored content items from one or more sponsors, wherein the sponsored content items include content specifically designed by a sponsor.

5. The method of claim 4, further comprising:
storing the one or more received sponsored content items in a database associated with a server system.

6. The method of claim 4, further comprising:
receiving one or more sponsored designated solutions for each sponsored content item.

7. The method of claim 1, wherein the interactive user exercise is one of a translation exercise, a verbal repetition exercise, a verbal translation exercise; a word matching exercise, a fill-in-the-blank exercise, action replication exercise, and a question and answer exercise.

8. The method of claim 1, wherein each interactive user exercise has one or more acceptable user responses.

9. The method of claim 8, wherein evaluating the user engagement with the sponsored content item based on the received user response includes:
determining whether the received user response matches one of the acceptable user responses; and
in accordance with a determination that the user response matches one of the acceptable user response, recording a positive user engagement record.

10. The method of claim 1, wherein each interactive user exercise has one or more hints.

11. The method of claim 10, wherein the one or more hints for an interactive user exercise that includes sponsored content are received from the sponsor of the interactive user exercise.

12. The method of claim 1, wherein the sponsored content item is one of a text-based content item, a video content item, and an audio content item and the user response is stored in one of a text file, a video file, and an audio file.

13. The method of claim 1, wherein the interactive user exercise is a multiplayer interactive user exercise and further comprises:
transmitting a first image to a first user;
receiving, from the first user, a description of the first image in a learning language;
transmitting the description of the first image to a second user;
transmitting a plurality of images including the first image to the second user; and
receiving from the second user a user response selecting one of the plurality of images as the image described by the transmitted description.

14. The method of claim 1, wherein selecting the one or more sponsored content items based on stored data for the user associated with the client system, further comprises:
accessing the user's profile;
based on information stored in the user's profile, determining the user's proficiency with the interactive user activity; and
based on the user's determined proficiency, selecting a sponsored content item appropriate for the user's determined proficiency.

15. The method of claim 1, wherein selecting the one or more sponsored content items based on stored data for the user associated with the client system, further comprises:
determining the number of sponsored content items presented to the user as part of an interactive user activity within a predetermined time frame.

16. The method of claim 1, wherein selecting the one or more sponsored content items based on stored data for a user associated with the client system, further comprises:
for a particular piece of sponsored content from a first sponsor, determining whether the user has seen other sponsor content from the first sponsor as part of an interactive user activity within a predetermined time frame.

17. An electronic device comprising:
a reception module, using at least one processor of a machine, to receive a content request from a client system;
a selection module, using at least one processor of a machine, to, in response to receiving a request from the client system, select one or more sponsored content items for a user associated with the client system, wherein the sponsored content items were created by one or more sponsors of an interactive user application;
a transmission module, using at least one processor of a machine, to transmit the sponsored content items to the client system for display as part of an interactive user exercise, wherein the user is prompted to provide a response to the sponsored content items;
a response reception module, using at least one processor of a machine, to receive a user response to the interactive user exercise from the client system; and
an evaluation module, using at least one processor of a machine, to evaluate user engagement with the sponsored content items based on the received user response.

18. The device of claim 17, wherein the interactive user exercise is a translation exercise for a language learning application.

19. A non-transitory computer-readable storage medium storing instructions that, when executed by one or more processors of a machine, cause the machine to perform operations comprising:
receiving a content request from a client system;
in response to receiving the content request from the client system, selecting one or more sponsored content items for a user associated with the client system, wherein the sponsored content items were created by one or more sponsors of an interactive user application;
transmitting the sponsored content items to the client system for display as part of an interactive user exercise, wherein the user is prompted to provide a response to the sponsored content;
receiving from the client system a user response to the interactive user exercise; and
evaluating user engagement with the sponsored content items based on the received user response.

20. The non-transitory computer-readable storage medium of claim 19, wherein the interactive user exercise is a translation exercise for a language learning application.
